(19) United States
(12) Patent Application Publication
(10) Pub. No.: US 2002/0173565 A1
(43) Pub. Date: Nov. 21, 2002

(54) Urea condensate fertilizer, fungicide and insecticide compositions

(76) Inventor: David H. Blount, San Diego, CA (US)

Correspondence Address: David H. Blount, 6728 Del Cerro Blvd., San Diego, CA, 92120, US

(21) Appl. No.: 09/941,402

(22) Filed: Aug. 30, 2001

Related U.S. Application Data
(63) Continuation-in-part of application No. 09/532,646, filed on Mar. 22, 2000, now Pat. No. 6,348,526.
Application No. 09/532,646 is a continuation-in-part of application No. 08/801,776, filed on Feb. 14, 1997, now Pat. No. 5,788,915.
Application No. 09/532,646 is a continuation-in-part of application No. 08/723,779, filed on Sep. 30, 1996, now Pat. No. 5,854,309.
Application No. 09/532,646 is a continuation-in-part of application No. 09/149,847, filed on Sep. 8, 1998, now Pat. No. 6,258,298.

(51) Int. Cl. C08K 5/34

(52) U.S. Cl. 524/100

(57) ABSTRACT

Fertilizer, fungicide and insecticide compositions are produced by the process of this invention. The partially hydrolyzed amino condensation compounds are produced by heating urea or heating urea with other nitrogen containing compounds that will condensate with or react with isocyanic acid and/or cyanic acid thereby producing an amino condensation compound which is then partially hydrolysis by reacting it with a limited amount of water. The partially hydrolyzed amino condensation compounds may be used alone or may be mixed with or reacted with salt forming compounds, aldehydes and fillers to produce a partially hydrolyzed amino condensation composition The partially hydrolyzed amino condensation salts of phosphorus, boron or sulfur containing compounds and the partially hydrolyzed amino condensation-aldehyde resins may also be used as the insecticide, fungicide and fertilizer compound in this invention.

This application is a continuation in part of U.S. patent application Ser. No. 09/532,646 filed Mar. 22, 2000, which is a continuation in part of Ser. No. 08/801,776, filed Feb. 22, 1997, now U.S. Pat. No. 5,788,915 and Ser. No. 08/723,779, filed Sep. 30, 1996 and a division of Ser. No. 09/149,847 filed Sep. 06, 1998.

### FIELD

The invention concerns urea being condensated with itself or with other organic compounds with a plurality of nitrogen atoms such as amino compounds to produce amino condensation compounds which is then partially hydrolyzed. The invention also concerns their preparation and use. The partially hydrolyzed amino condensation compounds are useful to produce insecticide, fungicide and rapid acting and long acting fertilizer products, and may be reacted with phosphorus a to produce other fertilizer and insecticide compounds. The partially hydrolyzed amino condensation compounds may also be reacted with aldehydes to produce partially hydrolyzed amino condensation-aldehyde resins for use as insecticides, fungicides, fertilizer, as an adhesive, coating resin or as a flame retardant compound.

### BACKGROUND

The heating of urea to produce urea condensation compounds, such as biuret and a mixture of cyanuric acid and cyamelide, is known in the arts, but the partially hydrolysis of these compounds to produce improved short acting and long acting fertilizer compounds is novel. U.S. Pat. No. 5,788,915 utilizes partially hydrolyzed condensated urea as a flame retardant. The condensation of urea with other organic compounds with a plurality of nitrogen atoms and their partially hydrolysis for use as a combined rapid acting and long acting fertilizer is novel. The condensation of isocyanuric acid and/or cyanic acid, (which are produced by heating urea),with other nitrogen containing compounds to produce fungicides, insecticides and rapid acting and long acting fertilizer compounds is novel. The partially hydrolyzed amino condensation compounds and their phosphorus and/or sulfate salts may be used as a fungicide, insecticide and a rapid acting and long acting fertilizer compounds.

What is lacking and what is needed are useful inexpensive partially hydrolyzed nitrogen containing organic compounds with a plurality of nitrogen moieties. The partially hydrolyzed amino condensation compounds and/or their salts of this invention and the partially hydrolyzed amino-aldehyde resins are novel fungicides, insecticide and rapid acting and long acting fertilizer compounds. What is additionally lacking are compositions having such partially hydrolyzed amino condensation compounds and/or their salts employed therein.

### SUMMARY

In one aspect, the invention comprises partially hydrolyzed amino condensation compounds and their salts which I named ammonium polyaminocarbamate. Another aspect of the invention is a process to prepare partially hydrolyzed amino condensation compound (ammonium polyaminocarbamate) and/or their salts comprising serially contacting, heating and reacting:

(A) urea;

(B) nitrogen containing compound that condensate or react with urea; then

(C) water;

(D) salt forming compound

under conditions sufficient to prepare the partially hydrolyzed amino condensation compounds (ammonium polyaminocarbamate). The urea is first heated to produce isocyanuric acid and/or cyanic acid then reacted with urea to form biuret or a mixture of cyanuric acid and cymelide or reacted with Component B or with more urea plus Component B to produce a mixture of biuret, cyanuric acid and cyamelide and condensed urea-nitrogen containing compound then they are partially hydrolyzed with a limit amount of water to produce ammonium polyaminocarbamate. A partially hydrolyzed urea condensate salt when an acidic and/or a basic salt forming compound is reacted with the partially hydrolyzed urea condensate

In another aspect, the invention comprises partially hydrolyzed amino condensation salt of phosphorus and/or sulfate and/or boron containing compound and a process to prepare a partially hydrolyzed amino condensation salt of a phosphorus and/or sulfate and or boron containing compound employing phosphorus and/or sulfur and/or boron containing compound that will react with the partially hydrolyzed amino condensation compound under conditions sufficient to prepare the partially hydrolyzed amino condensation salt of a phosphorus and/or sulfur and/or boron containing compound, and a process to prepare a partially hydrolyzed amino condensation salts of a phosphorus and/or a sulfur and/or a containing compound comprising serially contacting, heating and reacting:

(A) urea;

(B) nitrogen containing compound that condensates or react with urea; then

(C) water; then

(D) phosphorus and/or sulfur and/or boron containing compound that react with a partially hydrolyzed amino condensation compound.

component A and B are first heated and reacted, then a limited amount of water is added and heated to produce a partially hydrolyzed amino condensation compound, then component D is added and reacted. The limited amount of water may also be added with the urea then heated.

An addition aspect of this invention is the production of partially hydrolyzed amino condensation-aldehyde resins and a process to prepare partially hydrolyzed amino condensation-aldehyde resins under conditions sufficient to prepare the partially hydrolyzed amino condensation-aldehyde resin comprising serially contacting, heating and reacting:

(A) urea;

(B) nitrogen containing compound that will condensate or react with urea; then

(C) water; then

(E) aldehyde; and a

(G) a basic or acidic catalyst;

components A and B are first reacted to produce an amino condensation compound which is then partially hydrolyzed with a limit amount of water to produce a partially hydrolyzed amino condensation compound (ammonium polyaminocarbamate) which is then reacted with component E in the presence of component G. The water may also be added to the urea then heated.

An additional aspect of the invention is use of the partially hydrolyzed amino condensation compounds, partially hydrolyzed amino condensation salts of phosphorus and/or sulfur and/or boron compounds and partially hydrolyzed amino condensation-aldehyde resins as an insecticide and a rapid acting and long acting fertilizer compounds. The fertilizer, fungicide and insecticide compositions may consist of condensation compound (ammonium polyaminocarbamate) and/or a partially hydrolyzed amino condensation salt of a phosphorus and/or sulfur and/or boron containing compound, and/or partially hydrolyzed amino condensation-aldehyde resin and fillers.

The flame-retardant compounds of this invention are produced by heating urea (Component A) with urea or another nitrogen containing compound (Component By to above the melting point of urea to about 160 degree C. at ambient pressure for 0.1-3 hrs. Upon heating above the melting point urea forms a very reactive compound isocyanic acid which will react with itself or other urea or other organic or inorganic nitrogen containing compounds especially amino compounds. In order to increase resistant of plants to aphids and fungus addition compounds may be added or reacted with the fertilizer such as, potassium, phosphorus acidic compounds, or organic phosphorus compounds that will react with an amino compound is added to the melted partially hydrolyzed amino condensation compound (ammonium polyaminocarbamate) mixed and/or reacted. The partially hydrolyzed amino condensation compounds (ammonium polyaminocarbamate) may be further reacted with an aldehyde (Component D) in the presence of a neutral or basic or acidic catalyst by mixing and heating the partially hydrolyzed amino condensation compound with the aldehyde, usually in an aqueous medium, to just below the boiling point of the components at ambient or an elevated pressure thereby producing a partially hydrolyzed amino condensation-aldehyde resin (ammonium polyaminocarbamate-aldehyde). The urea condensates are useful as fungicides and insecticide but may be enhance by reacting boron oxyacid or their salts with the partially urea condensates and utilized as a fungicide and an insecticide especially for use to kill ants termites and cockroaches.

It is preferable to produce the partially hydrolyzed amino condensate (ammonium polyammocarbamate) by utilizing urea or a condensate of urea such as biuret or a mixture of cyanuric acid and cyamelide which is then heated with a limited amount of water for hydrolysis of the NH₂ radical or radicals to form —COONH₄ radicals on the partially hydrolyzed amino condensation compounds which has the general formula of:

H₄NOOC—(—NHCONH—)ₙ—COONH₄

wherein n is a number 1-8.

Partially hydrolyzed amino condensation compounds (ammonium polyaminocarbamate) may be produced by other means such as reacting ammonia and carbon dioxide under pressure and elevated temperature to produce ammonium carbonate, ammonium carbamate and urea in water. Most of the water is then removed under satisfactory physical conditions and by any satisfactory means such as crystallization, distillation or air dried. Usually at ambient temperature or at a temperature below the temperature that ammonium carbamate breaks down into ammonia and carbon dioxide. The water is removed until there is about 10 to 40 parts by weight of water to 100 parts by weight of urea present in the mixture. The mixture is then heated under satisfactory physical conditions, usually at ambient pressure and 100° to 160° C. The mixture is first heated to about 100° C. then slowly elevated to converted the urea to cyanic acid and ammonia. The cyanic acid then reacts with the NH₂ radical on the ammonium carbamate and with itself to produce a partially hydrolyzed amino compound (ammonium polyaminocarbamate). The partially hydrolyzed amino compound may be further hydrolyzed by reacting it's NH₂ radical with water to produce —COONH₄ radicals thereby producing partially hydrolyzed amino compounds with the general formula of:

H₂NOOC—(—NHCONH—)ₙ—COONH₄

wherein n is a number 1-8. Part of the ammonium carbamate lose water to from urea and part breaks down to ammonia and carbon dioxide which is recycled. A partially hydrolyzed amino condensation composition is produced containing ammonium carbonate and polyaminocarbamate. The —COONH₄ radical in the present of water releases ammonia rapidly and the rest of the radical is slowly broken down to urea then to ammonia.

### Component A

Urea is utilized as component A and may be in the form of a powder, crystals or a solid. Any suitable urea may be utilized that will react with a nitrogen containing compound. Urea is usually produced by reacting ammonia and carbon dioxide which is heated under pressure in a reactor containing water. The ammonia and carbon dioxide is reacted to form ammonium carbamate. Part of the ammonium carbamate reacts with water to form ammonium carbonate and part loses water to form urea. The ammonium carbonate and ammonium carbamate may be removed from the aqueous solution by low temperature distillation. They dissociated to ammonia and carbon dioxide and recycled. The urea is separated from the aqueous solution by crystallization or by a form of spray-drying. Urea is utilized in the amount of 50 to 100 parts by weight.

### Component B

Any suitable nitrogen containing compound that will react with isocyanic acid and/or cyanic acid may be utilized in this invention. The nitrogen containing compound may be an organic or an inorganic compound. Suitable organic nitrogen containing compounds may be an aliphatic, aromatic, cyclic, aliphatic-aromatic or aliphatic-cyclic compound such as, but not limited to, urea, urea derivatives for example, O-alkylureas, amino compounds, for example, melamine, melamine cyanurate, dicyandiamide, biuret, cyanuric acid, cyamelide, guanidine, cyanoguanidine, ammeline and aminoguanidine, guanidine carbonate, ammonium carbonate, alkyl carbamates, alkyl isocyanates, polyisocyanates, sulfamic acid, ammonium sulfamate, amines, polyamines, thioureas, alkylanolamine, polyamides, amino hydrogen phosphates, amidines, amides, aldimines, ketimines, amino carbonates, aminoborates, amino sulfates, thiourea derivatives, alkylanolamines, nitrites, etc., and mixtures thereof. Suitable inorganic nitrogen containing compounds such as, but not limited to, ammonium phosphate, diammonium phosphate, ammonium polyphosphate, ammonium borate, ammonium hydrogen sulfate, quaternary ammonium salts, ammonium bicarbonate, ammonium carbonate, ammonium carbamate etc. and mixtures thereof. The amino compounds are the preferred nitrogen containing compound. The nitrogen containing compound may be utilized in the amount of 10 to 300 parts by weight.

When urea reacts with an amino compound to form an amino condensation compound, it is partially hydrolyzed with water and then a partially hydrolyzed amino condensation compound is formed (ammonium polyaminocarbamate) with the general formula of:

(H₄NOOC—)ₙ(—NHCONH—)_{y}(—NHCNHN—)_{z}

herein n is a number 1-4, y is a number 1-8 and z is a number 0-4.

### Component C

Water is utilized in the amount of 10 to 40 parts by weight to 100 parts by weight of urea. Water may be added to the urea before it is heated or after it is heated and a condensate is formed.

### Component D

Any suitable aldehyde may be reacted with the amino condensation compounds. Suitable aldehydes include, but not limited to, formaldehyde, paraformaldehyde, acetoaldehyde, butyraldehyde, chloral , and other alkyl aldehydes, furfural, benzyl aldehyde and other aromatic aldehydes. Aqueous formaldehyde is the preferred aldehyde. The aldehyde may be used in the amount of 25 to 300 parts by weight.

### Component E

Any suitable salt forming compound may be utilized in this invention. Suitable salt forming compound are organic and inorganic phosphorus acids, boric acids or sulfuric acids and their salts. These acidic components are compounds such, for example, acids or salts, or their derivatives of sulfur, boron and phosphorus, such as, phosphorus oxyacids, boron oxyacids, sulfur oxyacids, boron-phosphates, phosphates, polyphosphates of ammonia, alkali metal hydrogen phosphates, alkaline earth metal hydrogen phosphates, phosphates of amines, polyamines, amino compounds, thioureas and alkyanolamines, but boric acid and its salts and their derivatives, organic phosphorus compounds and their salts, halogenated organic phosphorus compounds, their salts and their derivatives may also be used for this purpose. The salt forming compounds may be used in quantities of 0 to 300 parts by weight. When the salt forming compound is used it may be used in the amount of 1 to 300 parts by weight based.

The nitrogen and potassium containing salts of phosphorus acids are the preferred salts for use as a fertilizer. The nitrogen containing salts of boron-phosphate is the preferred salts for use as an insecticide and as a fungicide. The amino condensation salt of phosphorus compounds are produced by contacting the partially hydrolyzed amino condensation compounds (ammonium polyaminocarbamate) with a phosphorus containing compound that will react with an amino compound, under conditions sufficient to prepare a partially hydrolyzed amino condensation salt of a phosphorus containing compound. Suitable inorganic phosphorus compounds include, but not limited to, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, mono-metal hydrogen phosphates, ammonia dihydrogen phosphate, bromated phosphates, alkali metal dihydrogen phosphate and halogenated phosphate-phosphite and their halides and acids. organic phosphorus compounds include, but not limited to, alkyl, cyclic, aryl and alkyl-aryl phosphorus compounds, such as, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, aryl hydrogen phosphates, halogenated phosphonates esters and mixtures thereof. Partially hydrolyzed amino condensation borates may be produced by contacting boric acid and partially hydrolyzed amino condensation compound under conditions sufficient to prepare the partially hydrolyzed amino condensation borates which may also be utilized as a flame-retardant compound. Partially hydrolyzed amino condensation salt of boron-phosphates may be produced by contacting boron-phosphates and partially hydrolyzed amino condensation compounds under conditions sufficient to prepare partially hydrolyzed amino condensation salt of boron-phosphate compounds which may also be utilized as a flame-retardant compound. The salt forming phosphorus containing compounds will react with the partially hydrolyzed amino condensation compounds to form a partially hydrolyzed amino condensation salt of a phosphorus containing compound.

### Component F

Any suitable filler or bait may be used in this invention. The fillers may be inorganic substances, such as, alkali metal compounds, lime, alkaline earth metal silicates, metal silicates, silica, metals, oxides, carbonates, sulfates, phosphates, borates and organic matter such as cellulose materials. They may be organic substances, such as, amino compounds, such as urea, melamine, dicyandiamide, and other cyanuric derivatives or their formaldehyde resins, aminophosphates, amino salts of organic phosphates, and mixtures thereof. The fillers may also be substances that act as bait for insects such as carbohydrates, such as sugar, syrups, corn meal flour, etc., vegetable and fatty oils, and cellulose materials. Fillers may be added in the amount of 0 to 300 parts by weight. When the filler is added it may be added in the amount of 1 to 300 parts by weight.

Any suitable basic or acidic catalyst may be used in the reaction of amino condensation compounds with aldehydes. Suitable basic compounds include but not limited to, compounds containing alkali metal, alkaline earth metal and ammonia radicals and mixture thereof. Suitable acidic compounds include, but not limited to, halogen acids, acidic phosphorus containing compounds, acidic compounds containing sulfur, sulphonic acid, halides, carboxylic acids, polycarboxylic acids, nitric acids and mixtures thereof. In some reactions basic or acidic catalytic are not necessary. A catalytic amount is utilized.

### ILLUSTRATIVE EMBODIMENTS

In general, the partially hydrolyzed amino condensation compounds(ammonium polyaminocarbamate) are compounds which are produced by heating urea with urea or other nitrogen containing compounds that will condensate or react with urea to produce amino condensation compounds. The heated urea first form isocyanic acid and/or cyanic acid which polymerizes with itself to form a mixture of cyanuric acid and cyamelide and/or biuret. When urea is heated with another nitrogen containing compound, such as, melamine a different compound is formed. This compound is converted to a partially hydrolyzed compound by reacting water with the NH₂ radical of this compound to form NH₄OOC— radicals.

### DESCRIPTION OF PREFERRED EXAMPLES

The present invention will now be explained herein-after by way of a few examples and comparative examples, these examples setting, however, no limits to this invention. Parts and percentages are by weight, unless otherwise indicated.

### Example 1

Two-three heated moles of ammonia to one mol of heated carbon dioxide, heated at 160° to 210° C. is forced through a reactor which has an aqueous solution or oil-water slurry of ammonia and carbon dioxide which is being circulated at 160° to 210° C. and under 2-6000 psi to form ammonium carbamate which when heated lose 1 mol of water thereby producing urea. The urea is in the aqueous solution after being removed from the reactor is distilled to remove ammonium carbonate and undecomposed ammonium carbamate, which dissociate to ammonia and carbon dioxide. The urea is separated from the concentrated aqueous still-residue at a low temperature by crystallization or by a form of spray-drying known as periling. The temperature is kept low to prevent the formation of biuret. 30 parts by weight of water are added to 100 parts by weight of urea which is then heated to above the melting point of urea and up to about 160° degree C°. for 0.1 to 1 hour. Ammonia evolves from the melted urea thereby producing a partially hydrolyzed amino condensation compound (a mixture of a small amount of ammonium carbonate and partially hydrolyzed biuret). The partially hydrolyzed amino condensation compound (ammonium polyaminocarbamate) is ground into a fine powder.

### Example 2

Example 1 is modified wherein the aqueous solution containing ammonium carbonate, ammonium carbamate and urea is not distilled to remove the ammonium carbonate and ammonium carbamate but most of the water is removed from the mixture by distilling at a low temperature or by spray drying until 20 to 40 parts by weight of water per 100 parts by weight of urea remains. The mixture is then slowly heated at ambient pressure to elevate the temperature in order to melt the mixture then the temperature is slowly elevated to 120-160 degree C. and heated for 30 minutes. Ammonia evolves from the mixture. Part of the ammonium carbamate loses water and forms urea. The heated urea forms isocyanic which polymerizes with itself and reacts with the NH₂ radicals on the ammonium carbamate and some of the NH₂ radical are hydrolyzed to form NH₄ OOC— radicals thereby producing a mixture of ammonium polyaminocarbamate and ammonium carbonate. The mixture is pulverized into a powder.

### Example 3

About 100 parts by weight of urea beads are mixed with 30 parts by weight of water then heated to 120-160 degrees C., and heated for 30 minutes thereby producing partially hydrolyzed amino compound (ammonium polyaminocarbamate) which is cooled by spraying into a flow of air or cooled then pulverized into a powder.

### Example 4

About 100 parts by weight of granular biuret produced by heating urea, is mixed with 30 parts by weight of water then heated to above the melting point of biuret to 120-160 degrees C. for 30 minutes, ammonia evolves from the mixture, thereby producing a partially hydrolyzed biuret compound (ammonium polyaminocarbamate) which is pulverized into granules.

### Example 5

about 100 parts by weight of a mixture of granular cyanuric acid and cyamelide, produced by heating urea, are mixed with 20 parts by weight of water then heated to 120-160 degree C. for 30 minutes, ammonia evolved from the mixture, thereby producing a partially hydrolyzed amino condensation compound (ammonium polyaminocarbamate) which is pulverized into granules.

### Example 6

100 parts by weight of urea and 50 parts by weight of melamine are mixed then heated to above the melting point of urea and up to 160 degree C. for 0.5 to 2 hours. Ammonia evolves from the mixture thereby producing an amino condensation compound (urea-melamine condensation compound). 25 parts by weight of water are added to the amino condensation compound and heated to 110° to 130° C. for 30 minutes thereby producing a partially hydrolyzed urea-melamine condensation compound. The cooled partially hydrolyzed amino condensation compound is ground into a fine powder.

### Example 7

Example 6 is modified wherein 75 parts by weight of melamine is used instead of 50 parts by weight.

### Example 8

Example 6 and 7 are modified wherein another nitrogen containing compound is used in place of melamine and selected from the list below:

| | |
|---|---|
| a) | dicyandiamide |
| b) | guanidine |
| c) | aminoguanidine |
| d) | thiourea |
| e) | ethylamine |
| f) | diethylamine |
| g) | ammonium carbonate |
| h) | urea carbonate |
| i) | diethylanolamine |
| j) | ammonium sulfamate |
| k) | ethyl carbamate |
| l) | ethyl isocyanate |
| k) | biuret |
| l) | ammonium bicarbonate |
| m) | methylolurea |
| n) | methylthiocyanate |
| o) | melamine phosphate |
| p) | urea phosphate |
| q) | melamine borate |
| r) | guanidine carbonate |
| s) | aniline |
| t) | melamine cyanurate |
| u) | guanidine phosphate |
| v) | acrylonitrile |
| w) | urea |

### Example 9

About 100 parts by weight of the partially hydrolyzed urea-melamine condensation compound of example 6 is mixed with 25 parts by weight of phosphoric acid (75%) then heated to above the melting point of the partially hydrolyzed urea-melamine condensation compound for about 30 minutes thereby producing a partially hydrolyzed urea-melamine condensation salt of phosphoric acid.

### Example 10

Example 9 is modified by first reacting 5 parts by weight of boric acid with the 25 parts by weight of phosphoric acid thereby producing a boron-phosphate condensation compound and utilizing it in place of the phosphoric acid in example 9.

### Example 11

Example 9 is modified wherein another phosphorus containing compound is utilized in place of phosphoric acid and selected from the list below:

| | |
|---|---|
| a) | pyrophosphoric acid |
| b) | phosphinic acid |
| c) | phosphorus trichloride |
| d) | phosphorus oxytrichloride |
| e) | phosphorus oxide |
| f) | ammonium dihydrogen phosphate |
| g) | mono-aluminum phosphate |
| h) | dimethyl methyl phosphonate (DMMP) |
| i) | dimethyl hydrogen phosphite |
| j) | phenyl acid phosphate |
| k) | methylchlorophosphine |
| l) | phosphorus |
| m) | phosphorus thiochloride |
| n) | tris(2-chloropropyl) phosphate |
| o) | triphenyl phosphite |
| p) | tris 2-chloroethyl phosphite |
| q) | triethyl phosphite |
| r) | urea dihydrogen phosphate |
| s) | diethyl phosphite |
| t) | trimethyl phosphite |
| u) | dibutyl pyrophosphoric acid |
| v) | melamine hydrogen boron-phosphate |
| x) | hypophosphorous acid |
| y) | methyl amine salt of phosphoric acid |
| z) | O,O-dimethyl hydrogen dithiophosphate |

### Example 12

Example 3 is modified wherein a phosphorus containing compound selected from the list in example 11 is added to the urea before it is heated thereby producing a mixture of urea condensation salt of a phosphorus containing compound and partially hydrolyzed biuret salt of a phosphorus containing compound. The mixture is ground into a fine powder.

### Example 13

Example 9 is modified wherein 20 parts by weight of powdered dimelamine phosphate is added to and mixed in with the melted partially hydrolyzed urea-melamine condensation compound thereby producing a fungicide, insecticide and fertilizer amino condensation composition which is cooled and ground into a powder.

### Example 14

Example 9 is modified wherein 25 parts by weight of melamine powder are added to and mixed in with the melted partially hydrolyzed amino condensation compound thereby producing a partially hydrolyzed amino condensation composition.

### Example 15

100 parts by weight of urea, 50 parts by weight of melamine powder and 20 parts by weight of boric oxide are mixed then heated above the melting point of urea and up to 160 degree C. for 45 minutes while agitating. Ammonia evolves from the solution. About 30 parts by weight of water is added to the urea-melamine-boron compound and heated at 110°-130° C. for 20-30 minutes thereby producing a partially hydrolyzed urea-melamine condensation compound containing boric oxide. The compound is cooled, then ground into a fine powder.

### Example 16

100 parts by weight of urea, 30 parts by weight of dicyandiamide and 20 parts by weight of boric acid are mixed then heated above the melting point of urea and up to 160 degree C. for 0.5 to 1 hour. Ammonia evolves from the mixture thereby producing a mixture of urea-dicyandiamide condensation containing urea borate. 30 parts of water is added then heated at 110-130 degrees C. for 20-30 minutes. The mixture of partially hydrolyzed urea-dicyandiamide condensation containing urea salt of boric acid is cooled then grown into a fine powder thereby producing a flame retardant partially hydrolyzed amino condensation composition.

### Example 17

100 parts by weight of urea, 30 parts by weight of melamine phosphate are mixed then heated above the melting point of urea and up to 160 degree C. for 40 minutes thereby producing a flame retardant amino condensation salt of phosphate composition. 25 parts by weight of water is added and heated for 20-30 minutes thereby producing a partially hydrolyzed urea-melamine phosphate condensation. After cooling it is ground into a fine powder.

### Example 18

Example 16 is modified wherein 10 parts by weight of a phosphorus salt forming compound selected from the list below is added to and reacted with the partially hydrolyzed amino condensation composition containing boric oxide;

| | |
|---|---|
| a) | phosphoric acid |
| b) | pyrophosphoric acid |
| c) | dimethyl methyl phosphonate (DMMP) |
| d) | dimethyl hydrogen phosphite |
| e) | trimethyl phosphite |
| f) | phenyl acid phosphate |
| g) | phosphorus trichloride |
| h) | phosphinic acid |
| i) | phosphorus oxytrichloride |
| j) | ammonium dihydrogen phosphate |
| k) | dimethyl phosphoric acid |
| l) | diethyl ethyl phosphonate |
| m) | magnesium hydrogen phosphate |
| n) | mono aluminum phosphate |

### Example 19

Example 4 is modified wherein 20 parts by weight of a powdered filler selected from the list below is mixed with the powdered partially hydrolyzed urea condensation compound thereby producing a partially hydrolyzed amino condensation composition:

| | |
|---|---|
| a) | hydrated aluminum oxide powder |
| b) | hydrated sodium silicate powder |
| c) | melamine |
| d) | dicyandiamide |
| e) | urea |
| f) | melamine phosphate |
| g) | melamine borate |
| h) | ammonium phosphate |
| i) | ammonium pyrophosphate |
| j) | ammonium carbonate |
| k) | ammonium borate |
| l) | ammonium sulfamate |
| m) | guanidine |
| n) | guanidine carbonate |
| o) | urea phosphate |
| p) | silica powder |
| q) | phenol-formaldehyde resin powder |
| r) | aluminum phosphate |
| s) | thiourea |
| t) | hollow beads |
| u) | expandable graphite |
| v) | melamine salt of DMMP |
| r) | ammonium sulfate |
| s) | magnesium chloride |
| t) | antimony trioxide |
| u) | boron-phosphate powder |
| w) | melamine boron-phosphate powder |
| x) | ammonium boon-phosphate powder |

### Example 20

Example 17 is modified wherein another amino phosphorus containing compounds is selected from the list below and utilized in place of melamine phosphate:

| | |
|---|---|
| a) | dimelamine phosphate |
| b) | dicyandiamide phosphate |
| c) | urea dihydrogen phosphate |
| d) | guanidine phosphate |
| e) | aminoguanidine phosphate |
| f) | diethyltriamine urea phosphate |
| g) | melamine salt of dimethyl methyl phosphonate |
| h) | melamine salt of dimethyl hydrogen phosphite |
| i) | methylamine melamine phosphoric acid |
| j) | methyl carbamate salt of phosphoric acid |
| k) | melamine salt of boron-hydrogen phosphate |
| l) | O-methyl urea phosphate |
| m) | urea salt of boron-phosphate |
| n) | urea-formaldehyde phosphate |
| o) | aminophenol phosphate |
| p) | ammonium urea phosphate |
| q) | ammonium melamine phosphate |
| r) | melamine salt of trimethyl |
| | phosphite |
| s) | melamine salt of phenyl acid |
| | phosphate |

### Example 21

Example 5 is modified wherein the urea condensation compound is heated and reacted with 20 percent by weight of urea, percentage based on the weight of the urea condensation compound.

### Example 22

Example 8 is modified wherein the urea is first heated and reacted with itself to form a urea condensation compound then additional 20 percent by weight of urea, percentage based on the weight of the urea condensation compound, is added with the nitrogen containing compound.

### Example 23

25 parts by weight of phosphoric acid (85%) is reacted with a partially hydrolyzed amino condensated compound selected from the list below thereby producing a urea condensate salt of phosphoric acid:

1. 55 parts by weight of partially hydrolyzed urea condensation compound of Example 2.

2. 47 parts by weight of partially hydrolyzed urea condensation compound of Example 4.

3. 45 parts by weight of partially hydrolyzed urea condensation compound of example 5.

4. 50 parts by weight of partially hydrolyzed urea-melamine condensation compound of

### Example 24

A dozen of similar tomato plants of about 4-5 inches tall was planted in a garden then around 4 of the plants 50 grams of the partially hydrolyzed biuret produced in example 1 was placed around the plants. 50 grams of fertilizer containing 16% nitrogen was placed around 4 other tomato plants. 4 of the plants was not fertilized. The plants were watered every other day using the same amount of water. In 10 days the tomato plants that was fertilized grew about 3-4 inches taller than the unfertilized plants. After 30 days the plants fertilized with the partially hydrolyzed biuret continued to grow at a faster rate than the other plants and were taller, had more branches and was wider than the other plants. These plants also produced more tomatoes than the other plants.

### Example 25

Example 24 is modified wherein another partially hydrolyzed urea condensate which produced the same growth results is used in place of partially hydrolyzed biuret and selected from the list below:

1. Partially hydrolyzed urea condensate of example 2

2. Partially hydrolyzed urea condensate of example 4

3. Partially hydrolyzed urea condensate of example 5

4. Partially hydrolyzed urea condensate of example 6

### Example 26

Example 24 is modified obtaining the same good results using a partially hydrolyzed urea condensate salt of phosphorus oxyacid selected from the list below:

1. Partially hydrolyzed urea condensate salt of phosphorus oxyacid of example 9.

2. Partially hydrolyzed urea condensate salt of phosphorus oxyacid of example 19o.

3. Partially hydrolyzed urea condensate salt of phosphorus oxyacid of example 19h.

4. Partially hydrolyzed urea condensate salt of phosphorus oxyacid of example 19k.

### Example 27

3 inch pads covered with peanut butter diluted with peanut oil and containing 30 percent partially hydrolyzed biuret produced in example 1 was placed around 10 fire ant mounds. The mound was examined 3 days later and the fire ants had left 6 of the mounds. More pads containing the peanut butter was placed around 4 mounds containing ant and with in 3 days 2 of the mounds were free of ants.

### Example 28

A lid containing corn syrup which contained 10% partially hydrolyzed urea condensation salt of boron-phosphate produced in example 10 was place near an ant mound which contains sweet eating ants. The ants in the ant mound disappeared in three days.

### Example 29

The perimeter around a house contains plants which had a layer of pine needles and leaves around the plants. There was a lot of cockroaches under the pine needles and the plants were losing leaves and were in poor shape. On the north side of the house about 25 grams of 25 grams of partially hydrolyzed biuret produced in example 1 was placed around each plant. On the south side of the house 25 grams of urea-melamine condensate salt of phosphoric acid produced in example 17 and containing 5% sodium borate was placed around the plants. On the east side of the house 25 grams of partially hydrolyzed urea condensate with 5% ammonium borate produced in example 19k was placed around the plants. On the west side of the house 25 grams of partially hydrolyzed biuret salt of phosphoric acid was placed around the plants. The plants were then watered every 3^{rd} day. After one week each side of the house was examined for cockroaches by checking under the pine straws. The cockroaches had disappeared from all around the house.

After about 10 days new leaf buds began to show on the plants around the house and within 3 week the plants had new leaves and began to grow. After 2 month the plants continue to grow and develop new leaves and branches.

### Example 30

About 1 dozen of thin wood chips were sprayed with a 20% aqueous solution of partially hydrolyzed biuret produced in example 1, another dozen of wood chips were sprayed with a 20% aqueous solution of partially hydrolyzed biuret salt of phosphoric acid, and another dozen of thin wood chips sprayed with a 20% aqueous solution of partially hydrolyzed biuret containing 5% zinc borate were buried about 4 inches under the ground in a moist area near the house. These wood chips were dug up after being in the ground for 10 months. Since the treating materials are flame retardant the cleaned and dried chips was tested for residual fertilizer, insecticide and fungal side. The chips were flame tested and would not burn therefore they still contain some the partially hydrolyzed urea condensate. The chips were examined for any dry rot, termite infestation and fungus and none was found.

### Example 31

Various plants were collected from a nursery which were in very poor condition and were to be destroyed. These plants were watered with a 10% solution of partially hydrated biuret then watered daily. With in 10 days the plants begin to grow buds and new leaves. The plants continue to grow for 3 month without any addition of fertilizer and remained in very good condition.

### Example 32

The leaves of a peach tree contained aphides was sprayed with a 1% aqueous solution of potassium partially hydrolyzed biuret salt of phosphoric acid. The leaves were examined and found that the outer layer of the leaves had thickened and acted as a protection against aphides.

### Example 33

A board of fir lumber which had a 1″×6″ area of dryrot and had termite was sprayed with an aqueous solution containing 20% aqueous solution of partially hydrolyzed amino compound produced in example 3. The lumber was placed back into the termite containing firewood then it was re-examined after 10 months and the dryrot has not gotten any larger and there is no sign of new termite damage.

### Example 34

Several fir board was sprayed with an aqueous solution of partially hydrolyzed buiret salt of phosphoric acid then placed in a fire wood pile which contained termites, The boards were examined after 6 months and 1 year and no termite damage or dryrot was found.

### Example 35

An 8′×8′ tool shed was infested with cockroaches. The floor around the inside walls was sprinkled with partially hydrolyzed amino condensate salt of boron-phosphate powder. One week later all the cockroaches had disappeared, and several months later they were still gone.

### CONCLUSION

It is surprising that the partial hydrolysis of the amino condensation compounds greatly increase their insecticide, fungicide and fertilizing properties. The addition of salt forming compounds such as phosphoric acid and potassium phosphate increase the fertilizing immediate and prolonged effect and forms fungus and aphides protection. The addition of salt forming compounds such as phosphoric acid, boric acid and borates increase its effectiveness against insect such as ants, termites and cockroaches and against fungus.

It will be appreciated by those skilled in the Arts that changes and modifications of the preferred embodiment can be made without departing from the spirit and broader aspects of the invention as set forth in the appended claims.

I claim:

1. An insecticide, fungicide and fertilizer composition is produced by the process comprising of mixing, heating and reacting the following components:
(A). urea;
(B). nitrogen containing compound that condensates and/or react with isocyanuric acid and/or cyanic acid;
(C). water;
(D). Salt forming compounds;
(E). filler;
components A and B are first reacted to produce an amino condensation compound, then component C is added, mixed and reacted, thereby producing a partially hydrolyzed amino condensation compound, then component D is added and reacted thereby producing a partially hydrolyzed amino salt composition, and then component E is added and mixed.

2. An insecticide, fungicide and fertilizer composition of claim 1 wherein the nitrogen containing compound that will condensate and/or react with isocyanic acid and/or cyanic acid, produced by heating urea, is selected from the group consisting of urea, amino compounds, amines, polyamines, urea derivatives, thiourea, thiourea derivatives, guanidine carbonate, urea carbonates, ammonium carbamic acid, ammonium bicarbonate and mixtures thereof, in an amount of 10 to 300 part by weight.

3. The insecticide, fungicide and fertilizer composition of claim 1 wherein the salt forming compounds are selected from the group consisting of phosphorus containing compounds, boron containing compounds, boron-phosphate containing compounds and sulfur containing compounds, and alkali metal compounds and alkaline earth metal compounds, in an amount of 0 to 300 parts by weight.

4. The insecticide, fungicide and fertilizer composition of claim 1 wherein the filler is selected from the group consisting of urea, melamine, dicyandiamide, melamine cyanurate , amino phosphates, aminopolyphosphates, aminoplasts, phenoplasts, powdered synthetic resins, sawdust, carbohydrates, cyanuric derivatives or their formaldehyde resins, ammonium sulfate, ammonium phosphate, amino phosphates, potassium phosphate, amino sulfates, silica, alkali metal silicates, alkaline earth metal silicates, metals, metal silicates, oxides, carbonates, sulphates, phosphates and borates, potassium hydrogen phosphate and mixtures thereof, in an amount 0 to 300 parts by weight.

6. The insecticide, fungicide and fertilizer composition of claim 1 wherein the partially hydrolyzed amino condensation compound is a partially hydrolyzed urea-ammonium carbamate condensation compound.

7. The insecticide, fungicide and fertilizer composition of claim 1 wherein the partially hydrolyzed amino condensation compound is a partially hydrolyzed urea-urea sulfate condensation compound.

8. The insecticide, fungicide and fertilizer composition of claim 1 wherein the partially hydrolyzed amino condensation compound is a partially hydrolyzed urea-dicyandiamide condensation compound.

9. The insecticide, fungicide and fertilizer composition of claim 1 wherein the salt forming compound is a phosphorus containing compounds that reacts with the partially hydrolyzed amino condensation compound and utilized as the partially hydrolyzed amino condensation composition.

10. The insecticide, fungicide and fertilizer composition of claim 9 wherein the phosphorus containing compound is an acidic phosphorus compound.

11. The insecticide, fungicide and fertilizer composition of claim 9 wherein the phosphorus containing compound is an organic phosphorus containing compound.

12. The insecticide, fungicide and fertilizer composition of claim 1 wherein the partially hydrolyzed amino condensation composition is urea-guanidine condensation compound.

13. The insecticide, fungicide and fertilizer composition of claim 11 wherein the organic phosphorus compound is organic phosphite.

14. The insecticide, fungicide and fertilizer composition of claim 1 wherein the water is added to the urea before heating.

15. The insecticide, fungicide and fertilizer composition of claim 10 wherein the acidic phosphorus compound is phosphoric acid.

16. A method for producing insecticide, fungicide and fertilizer compositions consisting of partially hydrolyzed amino condensation composition produced by the method comprising of mixing, heating and reacting the following components;
(A). urea, in the amount of 100 parts by weight;
(B). nitrogen containing compound that condensates and/or react with isocyanic acid and/or cyanic acid produced by heating a urea compound, in an amount of 10 to 300 parts by weight;
(C). water, in the amount of 10 to 40 parts by weight;
(D). salt forming compound, in the amount of 0 to 300 parts by weight;
(E). filler, in the amount of 0 to 300 parts by weight;
component A with itself or components A and B are first reacted to produce an amino condensation compound, then component C is added, mixed, heated and reacted thereby producing a partially hydrolyzed amino condensation compound, then component D is added then mixed and/or reacted, and then component E is added and mixed.

17. The method of claim 16 wherein the partially hydrolyzed amino condensation composition is a partially hydrolyzed urea condensation compound having the general formula of:
(NH₄OOC—)ₙ(—NHCO—)_{y}
wherein n is a number 1-3 and y is a number 1-8.

18. The method of claim 16 wherein the partially hydrolyzed amino condensation composition is a partially hydrolyzed urea-amino condensation compound having the general formula of:
(NH₄OOC—)ₙ(—NHCO—)_{y}(NHCH—)_{z}
wherein n is a number 1-3, y is a number 1-8 and z is a number 0-8.

19. The method of claim 16 wherein the amino condensation composition is a partially hydrolyzed urea condensation compound.

20. The product produced by the method of claim 16.

21. A fertilizer, fungicide and insecticide partially hydrolyzed amino condensation compound produced by reacting 100 parts by weight of urea with 10-40 parts by weight of water under reaction conditions.
